(19) United States
(12) Patent Application Publication
(10) Pub. No.: US 2006/0177801 A1
(43) Pub. Date: Aug. 10, 2006

(54) Cassidy code

(76) Inventor: Noureddin Zahmoul, Houston, TX (US)

Correspondence Address: NOUREDDIN ZAHMOUL, 189 LITCHFIELD LANE, HOUSTON, TX, 77024-6029, US

(21) Appl. No.: 11/054,267

(22) Filed: Feb. 9, 2005

(51) Int. Cl. G09B 19/00

(52) U.S. Cl. 434/156

(57) ABSTRACT

Awareness about Basic Guttural Consonants, BGC, perdurable presence, since illo tempore, in Hamito-Semitic languages, and conspicuous absence among Indo-European and Uralic languages, raises a case of interest. Tunsi Long Range Comparison, LRC, with English and Suomi languages entails discovery of regular differences, alternations, and reversal patterns hidden in the data. A brand new approach emerges facilitating languages LRC, and easing Language Origins Research, LOR. My first claim is about an unvoiced consonant gamut available to offset each missing BGC. My second claim covers the useful, nontrivial, unobtrusive, original consonantal reversal phenomenon. The Cassidy Code is Sumerian, Grimm and Verner Laws sequel, alternating BGC with mostly unvoiced consonants or apocope entailing a forward shift of articulation basis, due finer pronunciation, and adding the transmogrifying reversals. The idea is to put forward a parallel code, in LRC of languages and LOR quests, to the focus on separate wide swaths of straight cognations.

### CROSS-REFERENCE TO RELATED APPLICATION

“NOT APPLICABLE”

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISC APPENDIX

“NOT APPLICATION”

### BACKGROUND OF THE INVENTION

Language Origins Research, LOR, and Long Range Comparison, LRC, of languages, are the invention fields. I speak fluently one of the Hamitic Languages, (Tunsi), as well as, at least one Semitic (Arabic) language. I have mastered, since my childhood in Tunis, the two of them. My college studies were about international business. I graduated at the Business School of Lausanne, Switzerland. During thirty some years I practiced diverse kinds of businesses (banking, bartering, industrial, and manufacturing). However, since the age of four, while speaking, exclusively, Tunsi at home, learning Arabic writing in Coranic school, French language in elementary school, and English in high school. I have been amazed by the differences between the alphabets, the missing ten Basic Guttural Consonants, BGC, in the French, and the eight lacking BGC in English. Long time after, during a business trip to Finland I was fascinated by the twelve consonant Suomi (Finnish) language, and its peculiar modus of plural (Sami, pl. Suomi). It is also an agglutinative language with the same plural process, as in Tunsi. The missing BGC, and the peculiar plural became an issue of acute importance to me.

At the age of fifty eight, I deliberately retired to spend seventy eight months at Indiana University (Bloomington) where I passed a Philosophical Doctorate in The Uralic Studies, with two minors in Suomi (Finnish) studies, and in “Paganism and Islam in Central Asia”. My Master dissertation was about: “An Etymological Grouping of the Finnish Words Participating in the Quantitative Gradation: PP>P”. And My Ph.D. dissertation treated The “Historical Layers of The Selkup Vocabulary”. The Selkup/Shelghum language is part of the Uralic languages, and still spoken by the Selkup people along the Taz river and the Arctic Circle, in Siberia, where a year is a day, half of it light, and the other half night. During my stay in Indiana, I mastered the common connections between eleven Uralic languages, and the methodology of their cognations researches.

On the planet Earth where we live together, the limits of the possible are the following two altarpiece factoids that are uncontrolled, incontrollable and incontrovertible:

In every second, the living forest (north of the Saharan areas) is moving by six microns. Its motion of 23° latitude during the last 130 centuries will reverse itself during the next same span of time. This is the Precession effect discovered by Milutin Malenkovitch (1930s). Precession ramifications created a seven degree north latitude (36th to 43rd) Mediterra Evergreen Zone, MEZ, a buffer zone, land of perpetual plenty, where several languages thrived with different consonantal gamut during the last 15,000 years (see Annex 1).

In every second, the world population increases by four more human beings. Two will be Buddhist Chinese, Hindu or South Asiatic. The other two will be Monotheist (Judeo, Christian, and Muslim believers). All Earth population communicates by means of faith, beliefs, and discourses. There are seven hundred remnant languages (98 of them are Indo European) according to Dr. Guyla Decsy (Global Linguistic Connections, GLC, 1983, 8), but only 300 according to Dr Johanna Nickols from the American Association for Advancement of Science, Berkeley, Calif. The association of LOR is actively trying to trace back the original Mother Tongue, MT. Hence adequate research is critically needed to show its existence and unifying effect.

During the Paris workshop (1997), (see Annex II), Dr G. Decsy underpinned the following:
a) Humans lived less than 1% (one percent) of their phylogenetic history with languages (i.e. 35,000 years out 5 millions year). b) Monogenesis is correct with regard to the sound production. All languages of the world produce vowels/consonants in the same way. c) Polygenesis is correct with regard to the sound sequence (word) production. d) Words in large were set up late (post 10,000). e) Grammar is a late variation of vocabulary based on frequency relationships. f) Lexicon precedes grammar. g) The natural form of plural is reduplication”.
   At the same workshop Dr B. H. Bichackjian, pinpointed the real problem of LOR, and “Paris Prohibition”:
We could make a meaningful contribution by tracing the development of linguistic features and by inferring the principles that have guided the evolution of languages. But that would require the abandoning of a cherished myth, and mainstream linguists are not ready for it”.
   The cherished myth started with Sir Rawlington (1860) when he discovered the Behustan rocks, and deciphered their three languages. In his LRC of the 98 Indo European languages he initiated the rationale of straight cognation. Since then, all LRC of the world languages, have focused on separate wide swaths of obvious cognations, and LOR's goal has been since tracing back “Mother Tongue” with the same traditional rationale. The BGC have been totally absent during the two Paris workshops of LOR (1985, and 1997).

My research aims to add a parallel path to the traditional way with my LRC of the three following Linguae Purae: Uralic Suomi, Sm, (with twelve consonants), Indo-European English (with eighteen consonants) and Hamitic Tunsi (with twenty eight consonants), (see Annex III). My approach differs from traditional rationale by including BGC with their alternates, and the reversals in order to transcend all boundaries between the, alleged, different phyla of languages.

If, by any chance, there were a “Mother Tongue” one might sense, its basic tenets and their remnant hidden paths, traces, patterns from the remnant languages, and particularly through the three Linguae Purae of the LRC, each of them belonging to an alleged separate phyla of languages. Three questions initiated my quest: A) Is there a problem inside the problem?. In order to make the Hamitic Tunsi language better explained, I made a presentation, “The Tunsi language” at Toronto, Canada during the “ICANAS 1990” (Annex V), and another about “the Massyl Alphabet”, being the source of the seven Mediterranean alphabets existent before Christ, (B.C.), (Annex VI), during the “Hong Kong ICANAS 1993”.

B) What is the problem outside the problem?.

C) What are the barriers, the missing components, the pattern of Regular differences, RD and the breakthrough(s)?.

### BRIEF SUMMARY OF THE INVENTION

Awareness about BGC perdurable presence, since illo tempore, in Hamito-Semitic languages and their conspicuous absence among Indo-European and Uralic languages, raises a case of interest. The Tunsi language thorough cryptanalysis and its LRC with English and Suomi languages entail discovery of RD, alternations, and reversals patterns hidden in the data. A brand new approach emerges facilitating LRC of languages, and LOR.

My first claim is about a gamut of mostly unvoiced consonants and apocope, as viable alternates for each BGC lacking in Indo European and Uralic languages, and perdurably omnipresent in Hamito-Semitic languages as a prequel of a code facilitating LRC of languages, eliminating barriers, bridging gaps between different phyla of languages and widening the fulcrum of LOR, due MT.

My second claim is about the frequent use of consonantal reversal (double metathesis, one for extreme, and one for median consonants) in a multitude of words crossing diverse languages phyla, adding an opposite direction to alternations, which systematically provides balance, in transcending all language phyla boundaries.

This winged-brand new code is Sumerian's sequel, alternating BGC with unvoiced consonants by a forward shift of articulation basis, due finer pronunciation on the one hand, and adding the transmogrifying reversals, on the other hand.

The whole idea is to put forward a parallel high way, in LRC of languages and LOR quests, to the focus on wide swaths of literal and obvious cognations. When I discovered the breadth of the reversals embodiment, it was fascination beyond belief. The two components of The Cassidy Code, are useful nontrivial unobtrusive, and defying traditional and usual rationale.

### BRIEF DESCRIPTION OF THE SEVERAL VIEWS OF THE DRAWING

“NOT APPLICABLE”

### DETAILED DESCRIPTION OF THE INVENTION

The Hamito-Semitic languages kept all the following BGC, and the (h)
gh dh [symbol] kh ε h τ th th ss tt
   Suomi, Hamitic phyla and Latin kept also the front vowels: (ä), (ö). The Hamito-Semitic writing eradicated the vowels, and kept the above mentioned BGC. Among the mentioned BGC, ε, τ, [symbol] , will be in Arabic letters. With respect to the recurrent LOR's fatal flaw, Dr G.Decsy (G L C, 1983, 40) imparts:
“Basic Laryngeal Noise: Assumably a group of very archaic (primary) sounds (Proto-Phonemes, Pre-Proto-Phonemes) produced in the Larynx-Pharynx-Velum area without participation of the (classical) articulatory organs (tongue, mouth cavity, lips, etc.) of the supra-laryngeal vocal tract (concept in Liberman 1975. 10-12). Practically, the ? (glottal stop), h (laryngeal fricative their pharyngeal (kh, gh), uvular (q, x) or velar (x, gh, ng) counterparts belong to this group. The Basic Laryngeal Noise (BLN) is the most common sound product of primates and other subhuman (apes, dogs) which are unable to move their tongues, mouth cavities, lips, etc. ((organs of the human supra-laryngeal vocal tract, see above) due to the lack of the corresponding (human) mental abilities (fine tune command of the tongue, lips, etc.). The BLN is the acoustic basis of coughing, laughing, crying, sighing, etc. It is also produced by humans who are speech-impaired_(dumb) as far as their inability to speak lies in the lack of power needed to articulate and fine tune the motion of the tongue, lips, etc. In terms of markedness, the BLNs are the least marked units of the phoneme palette and can be regarded as the most archaic primordial elements of the human sound sequence language. For details see Decsy 1977.
   On the other hand, only the unique laryngeal h is omnipresent. And Dr G. Decsy says (G L C 1983, 8):

The absence of the h seems to be an essential parameter on a global linguistic basis. I call this parameter “h-lessness”. Merritt Ruhlen, the author of the book A Guide of the Languages of the World,—My figures confirm his results that ca. 36% of the world languages and the world population is h-less. According to Ruhlen, of the 693 languages listed in his guide, 248 have no h in their phoneme system. They are distributed over the six macroareas of the earth as follows:

| | | | | | |
|---|---|---|---|---|---|
| Africa | 39% | (43 out | Europe | 35% | (46/133, |
| | | of 109). | | | with caucasus) |
| Asia | 38% | (35/92, | Oceania | 57% | (81/141) |
| | | Siberia | | | |
| | | and Asia) | | | |
| N. America | 19% | (28/145) | S. America | 21% | (15/73)″ |

The problem inside the problem: A schism emerged between the primordial languages, with their perdurable BGC, and the Classical Articulatory Organs Languages, CAOL. By ignoring BGC, the CAOL evolved separately from the Hamito Semitic phyla towards a neat and gradual simplification. It clearly appears that the LOR cannot trace back MT without including the BGC.

The problem outside the problem: A trend of gradual and irresistible simplification is omnipresent among the Indo-European, and the Uralic languages. This second question is more complex and needs a compleat and thorough knowledge of the Regular Differences (RD) between our three languages LRC. We need to look at them from every angle, to hover over words of interest, to reach critical insights as well as leads, to delve deeply and thoroughly in order to detect recurrent analogies, RD, and reversals (double metathesis one for the extreme, and the other for the median consonants). A complete reckoning of RD hidden patterns ought to be accomplished in order to reach a thorough understanding of the paradigms that guided their evolution. The Suomi language simplified the use of the mouthful of air, and eliminated all affricates, and guttural consonants (except d and h). Lauri Posti made conspicuous the h>s alternation in the Livonian language, (Annex IV). Among the Semitic languages, the Hebrew went along with the trend. Some BGC were uneasy to articulate by the Jews. Evolution, through BGC attrition, often prunes away unneeded voiced consonant by a tweak or a mutation. The Hamitic Berber vernaculars rife with BGC, do not take exception to the pattern of forward shift of articulation basis. The thin way pronunciation superseded the BGC articulation, among the 98 Indo-European languages. Seven thousand years before Grimm and Verner laws the Kiengin/Sumerian started the finer articulation, Eme Sal, and the trend is still streamlining all the language phyla of the world. We have a clear-cut distinction between Eme Gur and Eme Sal (see Mr M. L. Thomsen, The Sumerian Language, 1981, 87):

| Eme-gi | Eme-sal | | | |
|---|---|---|---|---|
| d > z | dug = ze.eb | ‘good, sweet’ | dugud = ze.bi-da | ‘heavy’ |
| g > b | igi = i. bi | ‘eye’ | sha-g = sha-b | ‘heart’ |
| g > m | digir = dim.me.er | ‘god, | gish = mu | ‘tree’ |
| g > n | sag = she.en | ‘head’ | | |
| h > g | ha.lam = ge.le.eg | ‘to destroy’ | | |
| m > n | munus = nunus | ‘woman’ | | |
| m > g | sum = ze.eg | ‘to give’ | | |
| n > l | nigir = li.bi.ir | ‘herald’ | | |
| n > m | nu.gig = mu.gi.ib | ‘hierodule’ | | |
| n > sh | nin = shen | ‘lady’ | | |
| s > z | sum = ze.eg | ‘to give’ | | |
| s > sh | sig = she.en | ‘brick’ | | |
| k > s | | | | |

And vowel changes are

| | | |
|---|---|---|
| a > e | alim = e.lum | ‘deer’ |
| i > e | inim = e.ne.eg | ‘word’ |
| i > u | i = u | ‘fat’ |
| u > e | udu = e.ze | ‘sheep’ |

Eme sal preempted the Grim law by avoiding the hard g>m, and b, and Verner law, by stating the g>d alternation.

What are the missing components?: During my seventeen year quest I have effectuated a deep cryptanalysis of the missing BGC. They seem to have been transient in the 98 Indo-European, and the 24 Uralic languages. Their transience means that the Mother tongue might have had the laryngeal h, as well as the other ten BGC. During their transience, they, gradually faded out (Lauri Posti, see Annex IV), and apocope or several unvoiced consonants might have superseded them. My cryptanalysis allowed me to detect a gamut of mostly unvoiced consonants, as viable alternates to each missing voiced BGC in the Indo European languages. While entwining words with their respective missing BGC, in order to reincarnate their completion and original complexion, it, systematically, appeared that I might have reincarnated the Hamitic Tunsi vocabulary. Ultimatly, the fundamental aim has always been, about reaching a smoother and thinner articulation called in Finnish “viene ããnne” or finer pronunciation. Hopefully, Simo Parpola in his publication, (Transliteration of Sumerian Problems and Prospects, 1975, 254) underlined the common denominator as follows:
“Most of the phonetic differences between Main dialect and Eme Sal can be explained as autonomous sound changes occasioned by a forward shift of the basis of articulation (U>I=high back>high front); (K>P>T=velar>labial/dental stop); (Ng>M, >N=velar>labial/dental nasal); (Sh>S=post-alveolar>alveolar fricative); (S>Sh)=alveolar>dental fricative), which seems to indicate that backward-flanged phonemes (i.e. narrow vowels, and labial or dental, including alveolar consonants) were considered ‘finer’ than their forward-flanged counterparts.”
   This spontaneous, automatic, and autonomous sound mutation by an instinctive and pliable mutation or apocope, is part of a harmony instinct embedded in human neuro system. Simplification, or intricacy and redundancy eradication is an integral part of human mindset. Nowadays, conventional initial mnemonics or acronyms like MRI, IRS, CPR, CNN, MSN, FDA, BGC, LRC, LOR, EU, AAAS, AARP, USA, URSS, NAFTA, UN, and ASAP, sound simpler, familiar, and EZ to process. The vowel free writing started with the Hamito-Semitic languages as a simplification. Getting rid of the vowels while keeping alive all the BGC, has been the panacea of Hamito-Semitic languages.

After a thorough research of all hidden mutations, and reversals, one can trace, discern, unveil, and infer through their developmental system, the following RD, apocope (▾), alternation (∞), reversal (θ)): (When you have q, you read Arabic [symbol] .) Hereafter some samples of my fatal flaw free LRC of the three languages, which illustrate the two components of “The Cassidy Code”:

Apocope: The Loss of One or Two Consonants; Symbol (▾) (Sixty Six Apocope)
Ghloq ▾ lock; zaεfran ▾ safran; εarak ▾ argue; τshame ▾ shame; τalfa (creation) ▾ alfa/beta; ξilla ▾ ill; τabib ▾ (Tell) aviv; leτaf ▾ leaf; leτafa ▾ veil; εaber (cross) ▾ over; salaεa (merchandise) ▾ sale; zahow ▾ joy; biεa (sale) ▾ buy; qallel ▾ quell; chaεal ▾ coal; tellaε ▾ tell; ayatellaε ▾ ajatella (Sm) think; shaτta ▾ shot; laττad ▾ lade; εadel ▾ deal; feτal ▾ veal; taεam (feed) ▾ tame; tabεa ▾ mud; kaεba ▾ cube; garbaε ▾ brag; dhaεif (weak) ▾ deaf; shaεar ▾ hair; daεεam ▾ dam; εaqrab ▾ crab; seyyes ▾ seek; εuima ▾ uima (Sm) swim; εarab ▾ Arab; εakkel ▾ keel; εaggil ▾ agile; hetu ▾ etu (Sm) upfront; εaqish ▾ sick; τajez ▾ aegis (Zeus helmet); raaτ ▾ err; leτas ▾ leak; kawash ▾ cook; sahhel ▾ lease; saqsi ▾ ask; habbat ▾ abate; barcha ▾ much; shoruba ▾ soup; εtoss (sneeze) ▾ toss; shawwash ▾ chaos; yades ▾ cede; rakrak ▾ brew; samagh ▾ sap; εegge (omelet) ▾ egg; sellef ▾ help; sayyeb ▾ pause; noq (ba) ▾ hole; rashaτ ▾ score; εassess (guard) ▾ assess; εirak ▾ Irak; woffer ▾ offer; wolla ▾ olla (Sm), to be; εayeb ▾ lame; εataf ▾ pity; τawa ▾ eve; τaloosi ▾ loose; saτir ▾ raise; tiτfa ▾ fit; τassib ▾ boss;

Alternations: Symbol (∞); (Ninety Nine Alternations)
τob ∞ love; roτt ∞ lost; w\overline{a}τ\overline{a}m ∞ whim; yalaf ∞ glove/wrap; τresen ∞ he(vo)sen (Sm) horse); gozzom ∞ cutter; shnowe ∞ clue; shnow ∞ know; τ\overline{a}n\overline{a}sh ∞ snake; τaosa ∞ chaos; fluss ∞ b\overline{a}rsh\overline{a} ∞ plus; nood ∞ lot; dhaw ∞ day ∞ daw(n); luul ∞ noon; noer (light) ∞ noel; bussa ∞ kiss; τanoot ∞ saloon; τewel ∞ spell; τanoot ∞ huoneta (Sm) room; τlewet ∞ sweet; gorom ∞ grow; shaεur ∞ hair; qtal ∞ kill; εaaly ∞ fly; Skhon ∞ Sauna (Sm) ∞ Hot; druε ∞ drug; εessa ∞ Jesus; maliτ ∞ well; εaal ∞ well; εoqda ∞ knot; meshta ∞ metsa (Sm), slope forest; maτal ∞ mall; waτal ∞ wall; εafy ∞ safe; Shaaε ∞ shine; dallaε ∞ wild; εanter ∞ wonder; εuima ∞ swim; kesawa ∞ kesalla (Sm) coat; τoot ∞ cod; τila ∞ sin; taτin ∞ thin; τaion ∞ Sion; sabra ∞ Hebrew; neqqes (lower) ∞ negoci(ate); τalib ∞ milk; εood ∞ wood; tawa ∞ now; rafiε ∞ θ super; εaned ∞ deny; τolew ∞ honey; marfaε ∞ supreme; bartaε ∞ storm; εawwej ∞ skew; τasew ∞ stew; baε ∞ bow; εarq ∞ nerv; kwarraε ∞ quarrel; roqεa ∞ rogue; ghallaf ∞ wrap; τafna ∞ span; toτch ∞ chest; talfaτ ∞ split; shiτa ∞ sky; sha/faC ∞ swell; rattaτ ∞ settle; τassel ∞ hassle; τook ∞ hook; τanaak ∞ cheek; sfinge ∞ sponge; dhaad ∞ thaw; τalloma ∞ Salome; dharreτ ∞ dress; fucτ ∞ fuss; dhaher ∞ there; dhrif ∞ dwarf, small; τal ∞ sol; τazaq ∞ squeeze; eleεa ∞ elevä (Sm) ∞ life; neb (rä) ∞ new; ferraq ∞ break; Snaan ∞ stale; fayadh ∞ flood; soatt ∞ sound, voice; feeq ∞ wake; fej ∞ way; fowwar ∞ power; keb(ab) ∞ chop; rooq ∞ look at; wooza ∞ goose; Sers ∞ kirk; Shamata ∞ spite; freek ∞ fresh; heleq ∞ hulku (Sm) ∞ wreck; garn ∞ horn; walada ∞ birth; Jellaz ∞ Djellas ∞ zellas ∞ Dallas ∞ Gallas ∞ Gallaτ ∞ Wallace ∞ Ellas ∞ Allah: sunshine, sunrise slope, burial ground; khatwa ∞ step; τelam ∞ dream; εasel ∞ hazel, honey; τalefa (creation) ∞ kaleva (Sm) ∞ khalefa (Ar) ∞ alpha (Gr). Alternation of vowels: (u) alternates with (i): kif ∞ fun. (same as vowel alternations in Sumerian)

Reversals: Symbol (θ); (One Hundred Thirty Two Reversals), For Instance: Form ∞ θ Morph (Gr).
τaq ∞θ case; woh θ how; chum θ much; farq ∞θ grief; shenneb (moustache) ∞θ panache; kheet ∞θ tex; meel ∞θ lean; med ∞θ tend; enbuba ∞θ bubble; malaf θ film; doulash (stroll) ∞θ cloud; roanoqe ∞θ honor; roanoqe∞ ∞θ glory; arget θ tiger; gedes ∞θ hedge; darja ∞θ grade; εajib θ magic; feluka ∞θ (chaloupe) ship; karreshco θ carve; lellash ∞θ clean; tarf ∞θ part; mardh (illness) ∞θ drama; mardh ∞θ trap; khareq ∞θ cross; karreta (Fr. charrete) θ truck; kash ∞θ hate; kharam ∞θ murky; qadesh ∞θ stake; jelba ∞θ flock; gurt ∞θ drug; ghof ∞θ fog; deen θ need; rouτ ∞θ soul; tafsha ∞θ spot; nanaτ ∞θ stain; gueresh ∞θ charge; dis ∞θ hide; soτleb ∞θ bliss; τrabaha ∞θ hubris; εassida ∞θ dicey; r\overline{a}wey\overline{a}q ∞θ queer; derwish ∞θ shrewd; w\overline{a}τsh ∞θ miss; tasila θ list; kif ∞θ fun; mallas θ slam; shkob\overline{a} ∞θ back (wards); τ\overline{a}r\overline{a}s ∞θ serious; batτa ∞θ stage; rakah ∞θ Secure; qallaq ∞θ challenge; t\overline{a}riτ\overline{a} ∞θ hurt; dooleb ∞θ blood; tarf ∞θ part; khartum ∞θ matrix; mardokh ∞θ extreme; tophet ∞θ depot; tharwa ∞θ worth; τajama ∞θ magic; kolfa ∞θ police; yarab ∞θ pray; qortas (pack) ∞θ strong; ξakish ∞θ sick; zalabia ∞θ blaze; rad θ dare; qerqesh ∞θ segregate; rabukh ∞θ huber; falgat ∞θ dwarf; nidham ∞θ model; fetewa ∞θ modify; rashema ∞θ measure; ennihr ∞θ Rhine; neef ∞θ feel; faj ∞θ gap, way; ferqa ∞θ group; mehob ∞θ boheme; ghrof ∞θ fork out; qoffa ∞θ bag; fartas ∞θ strip; fatnas ∞θ satisfy; fassas ∞θ stave off; niya ∞θ aim; fayyash ∞θ achieve; fayesh ∞θ chief; fawwaj ∞θ jump; qaddesh ∞θ stake; mar θ rim; ferfed ∞θ develop; fannesh ∞θ sniff; qartes ∞θ strangle; qarraq ∞θ crave; lutf ∞θ futile; rawe ∞θ aware; εaraq ▾θ cure; farret ∞θ drift; dellej ∞θ delude; doq ∞θ shot; dammaq ∞ ▾ θ good; flit ∞θ slip; dammej θ jammed; darreq ∞θ cheat; damagh ∞θ ▾ .head; dawa ∞θ mede (cine); dell ∞θ elude; saroq ∞θ crook; romτ ∞θ spear; delil ▾ θ lead; talee θ late; nefaε ∞θ weapon; lewwaτ ∞θ severe; εonf ∞θ final; ξarch ∞ ▾ θ crew; εaffes ∞θ spur; qasheε ∞θ seek; ghallet ∞θ delay; dowiw ∞θ beyond; tiτfa ∞θ fit; lewwaτ ⋆ θ shelve; ezeekesh ∞θ squeeze; qeshqesh ∞θ tactic; Jellaz ∞ Dallas ∞ ▾ Ellas ∞ Ellah ∞θ Hay (Sum.) (Eastside/Sunrise, Burial Holy Ground); Sellala ∞ Selala (Sm) ∞θ Sunna (Ar) ∞θ Legacy; Ydhahhak ∞ Izahhak ∞ Isaac ∞θ Cassidy (Laughter); mermez ∞θ simmer; khif ∞θ fix; kif ∞θ wise; kyf θ fun; τoka ∞θ Bokh ∞ box; Dhaw ∞Day ∞ Daw(n) ∞θ God;

All the above mentioned samples reveal a sound, out off the wall, and easy to manipulate code for future LRC of languages, and LOR. We Know that the Suome s superseded z, sh, ch, tz, dz, ts, tsh, ε, and τ. And that Selkup ng mutated into n, m, g, k, w, and ▾ (apocope). Predictably, Sumerian alternations, and their sequel might play a pivotal role in the LOR, due MT, according to the following BGC alternations gamut.

| BGC | ▾ | ∞ | ∞ | ∞ | ∞ | ∞ | ∞ | |
|---|---|---|---|---|---|---|---|---|
| Gh | ▾ | G | W | F | Ng | | | |
| Dh | ▾ | D | Z | S | B | | | |
| [symbol] Q | ▾ | K | W | G | T | Ng | Ll | Gl |
| Kh | ▾ | J | Y | Sh | H | LL | S | |
| [symbol] | ▾ | W | V | Sh | H | S | F | L |
| H | ▾ | K | S | Sh | [symbol] | T | [symbol] | |
| [symbol] | ▾ | H | S | Sh | D | K | F | L |
| Th | ▾ | T | D | K | Z | | | |
| th | ▾ | T | D | F | S | | | |
| Ss | ▾ | T | D | S | Z | | | |
| Tt | ▾ | T | S | Sh | Z | | | |

Kiengin/Sumer alternations, Grimm law, Verner law, and Lauri Posti's dissertation confirm the same paradigm. Had they known and articulated BGC, Grimm, and Verner, would have systematically encapsulated them in their main laws. Regretfully, nobody has tried this opportunity before. Even, while deciphering the Sumerian language, huge errors have been committed by scholars. For instance, about the ride of the sun: Ai, (sunrise) instead of τai; gul (culminate) instead of ghul, Aninut (sunset) instead of εaninut The three most important consonants among BGC (τ, ε, gh) are missing in Sumerian deciphering.

KIENGIN: Ki>Su (i>u), Ng>M, iN>eR>SUMER, land of the faithful Lord (S, Langdon, The Sumerian Grammar, page 1). Any person of ordinary skill in the LRC, of languages and LOR, could apply Sumerian alternations with The Cassidy Code as an easy working template. This is a huge tectonic shift due MT.

Assumably, all fictitious language barriers and phyla boundaries seem to become more superfluous, artificially manmade fences, and redundant hurdles. The schism between the primordial and the CAOL languages is bridged. Hopefully, The Cassidy Code might facilitate reaching cognation of Basque and deciphering of Etruscan languages. Several barriers will be eliminated on the MT road. Hereafter alternation and reversal samples easy to process according to the Sumerian alternations, and The Cassidy Code:
tafsha ∞θ spot; mermez ∞θ simmer; kif ∞ wise/shape; rakaτ ∞θ ∞ secure; kyf ∞θ fun; nefata ∞θ weapon shnowa ∞ ∞ clue ∞∞ know ∞θ monk; ghamza ∞∞ wink; τewa ∞ ▾ eva; tell τrabib ▾ ∞∞ Tel aviv; tharwa θ worth; thor (ox) θ roth;; who θ how; chum θ much; rouτ ∞θ soul; eläεä ∞ elävä (Sm) ∞ ▾ life; dooleb θ blood; säläεä ▾ sale; τara ∞ four; τoma (neighborhood) ∞ home; τoush ∞ house; khif ∞θ fix; Yousef ∞ Joseph ∞ Jehovah(Hb) ∞ kasem (Ar), Guiseppi (It); raτama (Ar) ∞∞θ masr (Egypt); τaram, center ∞ haram (Ar) Pyramid; Sellälä ▾ Seldla (Sm) ∞ Sunna (Ar) ∞θ Legacy; τoka θ Bokh ∞ box Jellaz 00 Dallas ∞ Colli(na)s (Sp) ▾ ∞ Ellas ∞ Ellah ∞θ τay (Sum.) (Eastside, Sunrise, Holy Ground, cemetery) Ydhahhak (Laughter) ∞ Izahhak ▾∞ Isaac (Hb) ∞θ Cassidy; Dhaw ∞Day ∞ Daw(n) ∞θ God.

1. What I claim as my invention is: a gamut of mostly unvoiced consonants as viable alternates for each Basic Guttural Consonants, BGC, lacking in Indo European and Uralic languages and perdurably omnipresent in Hamito-Semitic languages, as a prequel of a new code facilitating LRC of languages, eliminating barriers, bridging gaps between different phyla of languages and widening the fulcrum of LOR, due “Mother Tongue”.

2. What I claim as my invention is: the use of consonantal reversal (a double metathesis, one for extreme, and one for median consonants) in several words crossing several phyla of Languages as a sequel to my first claim, adding an opposite direction to the alternations, which systematically provides balance, and transcends all alleged language phyla barriers and boundaries.
